(19) United States
(12) Patent Application Publication
(10) Pub. No.: US 2019/0360624 A1
(43) Pub. Date: Nov. 28, 2019

(54) FAST CONNECTION SPRING ACTIVATED LOCKING FLUID COUPLER FITTING

(71) Applicant: Corey A. Waller, Harrison, OH (US)

(72) Inventor: Corey A. Waller, Harrison, OH (US)

(21) Appl. No.: 16/250,655

(22) Filed: Jan. 17, 2019

Related U.S. Application Data
(60) Provisional application No. 62/676,456, filed on May 25, 2018.

(51) Int. Cl. F16L 37/086

(52) U.S. Cl. CPC F16L 37/086

(57) ABSTRACT

Provided is a quick-connect fitting assembly for quick connect and disconnect of a pair of fluid conduits, including a male member and female member of similar circumferences, so as to allow the female member to receive the male member. The female member contains a lock housing with a plurality of locking pawls and gaskets. The locking pawls can be radially displaced by the insertion of the male member into the female member. The assembly includes a release ring, which is captive to the male member snout. The release ring should be of similar circumference to the male member snout, but able to slide freely. When the connected assembly is ready to be disconnected, the release ring can be slid into the female receptacle area, radially displace the locking paws, and release the male member.

### RELATED APPLICATIONS

This application claims priority to U.S. Provisional Patent Application No. 62/676,456, filed May 25, 2018, and incorporates the same herein by reference.

### TECHNICAL FIELD

This invention relates generally to quick connecting and disconnecting conduit fittings or coupling devices. More particularly, embodiments of the present invention relate to such coupling elements for pressurized fluid transfer.

### BACKGROUND

Pressurized fluid transfer has been used in various industries for years. Particularly, the process of hydraulic fracturing (“fracking”) requires injecting liquid at high pressure into subterranean rock, boreholes, etc. in order to create cracks in the deep-rock formations through which natural gas, petroleum, and brine will flow more freely. To enable the fracking fluid to reach the subterranean rock, it must be pumped from a pumping mechanism through hoses and pipes. With the length that the fracking fluid must travel, multiple conduit fittings or coupling devices are needed. The typical conduit fitting or coupling device used in the industry is cumbersome and time-consuming to connect and disconnect.

When setting up and breaking down the fracking operation, operators must use additional tools including but not limited to hammers and wrenches, to affix the coupling devices to hoses, pump sources, and the like. This process is time intensive and labor intensive. The process of threading the connections onto hoses, pump sources, and the like takes extensive time, significantly increasing commercial costs. Also, the set up and break down process can cause injury when the operators misuse the hammers, wrenches, and other tools. Additionally, the use of additional tools raises costs.

In recent years, environmental concerns have been receiving significantly more attention and various governmental agencies have responded by implementing stringent regulations to reduce or prevent pollution. Particularly, fluid transfer industries are receiving criticism for leakage of fluids in to the surrounding environment, which in turn negatively affect the adjacent ecosystems. Common sources of fluid leaks and fluid spills are the conduit fittings or coupling devices. Currently, the industry uses conventional coupler fittings, which are known to be prone to leakage after abuse sustained from the set up and break down of the fluid transfer systems. The present invention addresses this leakage problem, while providing fluid connections and disconnections of conduit couplings.

### SUMMARY OF THE INVENTION

The present invention provides a leak-proof fast connecting and disconnecting apparatus for fluid coupler fitting. It includes a male member, a female member, and a release ring. The male member and female member are of a circumference that allows the female member to receive the male member. The release ring is of a circumference that allows it to slide freely upon the male member snout. While connected the release ring can engage the female member to quickly release the male member.

Other aspects, features, benefits, and advantages of the present invention will become apparent to a person of skill in the art from the detailed description of various embodiments with reference to the accompanying drawing figures, all of which comprise part of the disclosure.

### BRIEF DESCRIPTION OF THE DRAWINGS

Like reference numerals are used to indicate like parts throughout the various drawing figures, wherein:

FIG. 1 is an isometric view of a female part of a coupling according to an embodiment of the invention configured for hose attachment;

FIG. 2 is an isometric view of a male part of a coupling according to an embodiment of the invention configured for threaded attachment;

FIG. 3 is a cross-sectional view taken substantially along line 3-3 of the female part, shown in FIG. 1, and male part, shown in FIG. 2, unconnected;

FIG. 4 is a similar cross-sectional view as the male member displaces the locking pawls as the male and female parts are being connected;

FIG. 5 is a similar cross-sectional view showing the female and male member fully connected.

FIG. 6 is cross-sectional view of the female and male parts, showing a release ring displacing the pawls; and

FIG. 7 is a cross-sectional view of the connected female and male parts, taken substantially along line 7-7 of the female member.

### DETAILED DESCRIPTION

With reference to the drawing figures, this section describes particular embodiments and their detailed construction and operation. Throughout the specification, reference to “one embodiment,” “an embodiment,” or “some embodiments” means that a particular described feature, structure, or characteristic may be included in at least one embodiment. Thus appearances of the phrases “in one embodiment,” “in an embodiment,” or “in some embodiments” in various places throughout this specification are not necessarily all referring to the same embodiment. Furthermore, the described features, structures, and characteristics may be combined in any suitable manner in one or more embodiments. In view of the disclosure herein, those skilled in the art will recognize that the various embodiments can be practiced without one or more of the specific details or with other methods, components, materials, or the like. In some instances, well-known structures, materials, or operations are not shown or not described in detail to avoid obscuring aspects of the embodiments.

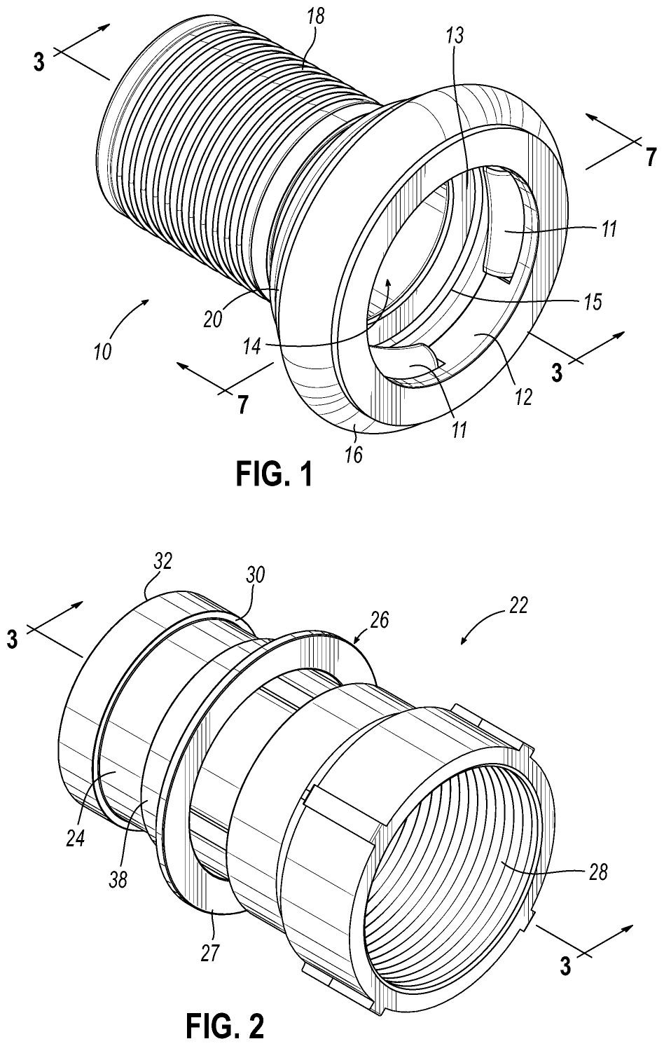

Referring first to FIG. 1, therein is shown at 10 a female member of a coupling in its entirety according to an embodiment of the invention. The female member includes a female lock housing 12 with a female receptacle area 14, a bumper 16, and a hose connection end 18.

The female lock housing 12 has a plurality of locking pawls 11 with three being a workable number. The number of locking pawls 11 should not be so great as to incur unnecessary additional manufacturing costs or so few as to make an unbalanced or strained connection.

The female receptacle area 14 includes a face gasket 13 that will withstand pressures and vaccums experienced in the desired applications, not limited to high-volume fluid transfer. The face gasket 13 generally has a diameter similar to that of the female lock housing 12 so that the face gasket 13 forms a tight bond allowing no fluid leakage. The female receptacle area 14 may also include a V gasket 15 that may create an initial seal that will withstand the pressures experienced in the desired applications, such as 5psi seal, although lighter on lower pressures can be used. The V gasket 15 may have a diameter similar to that of the female receptacle area 14 so that the V gasket 15 forms an initial seal, and permanent seal, which prevents fluid leakage should fluid breach the face gasket 13. The face gasket 13 is located behind the V gasket 15, and closer to the hose connection end 18 than the V gasket 15. The V gasket 15 may have a flexing fin 17.

To protect the coupling in rough handling environments, an elastomeric ring or bumper 16 may be included, such as on the outer part of the lock housing 12 of the female member 10. The diameter of the bumper 16 should be selected large enough that it will be likely to contact other objects or hard surfaces and absorb impact to the coupling.

The hose connection end 18 may be a crimped hose to hose fitting, threaded fitting, or the like. The hose connection end 18 and female lock housing 12 connect at the lock retainer 20.

Referring next to FIG. 2, therein is shown at 22 a male member of a coupling according to an embodiment of the invention in its entirety. The male member 22 may include a male member snout 24, a release ring 26, and a conduit connection end 28.

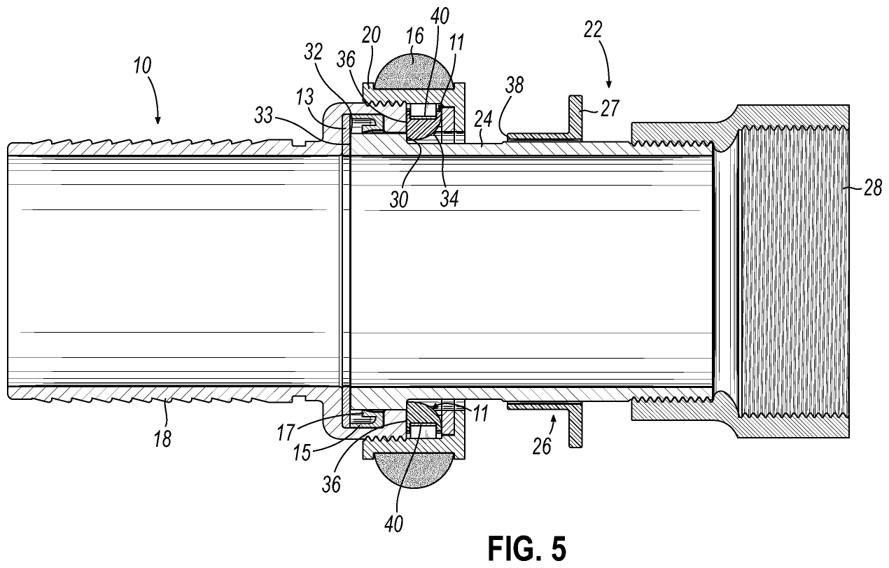

The male member snout 24 has an annular locking lip 30 and leading snout end 32. The distance between the annular locking lip 30 and the leading snout end 32 needs to be sufficient so as to lock into the female lock housing 12 (FIG. 1), but should not be so great as to incur unnecessary additional manufacturing costs or material used. The annular locking lip 30 needs to have a sufficient depth so that it may rest behind the locking pawls 11 when the locking pawls 11 have biased back to their original positions after the annular locking lip 30 has axially moved past the locking pawls 11 towards the hose connection end 18 to hold the male member 22 liquid tight with the face gasket 13 and the V gasket 15 (FIG. 5).

The male member snout 24 should be long enough to allow the release ring 26 to freely axially slide along the male member snout 24 whether or not the male member 22 is or is not engaged with the female member 10 (FIG. 1), but not so great as to incur unnecessary additional manufacturing costs. The release ring 26 should have a similar interior circumference to the male member snout 24 but not be so small as to prevent the release ring 26 from freely axially sliding on the male member snout 24, nor so large that the release ring 26 moves too freely as to allow unnecessary additional vibrations on the male member snout 24. The release ring 26 should have a smaller circumference than the conduit connection end 28 so that the release ring 26 is captive and cannot pass axially over the conduit connection end 28. The release ring 26 may have a release ring flange 27 that extends outwardly from the male member snout 24, which allows for ease of handling by an operator in the disconnection of the male member 22 from the female member (FIG. 1).

The male member 22 should have a circumference smaller than the female receptacle area 14 (FIG. 1) to allow clearance for insertion without unnecessary friction or wear, but not so small that a fluid tight seal cannot form.

The male member snout 24 and the conduit connection end 28 may be threaded together, with the release ring 26 located between the male member snout 24 and the conduit connection end 28.

The conduit connection end 28 may be a crimped hose fitting (not shown), threaded fitting, or the like. The hose connection end 18 (FIG. 1) may be a crimped hose to hose fitting, threaded fitting (not shown), or the like. A person of ordinary skill in the art would understand the best ways to use both a threaded fixed fittings and a hose to hose fittings separately or in combination and would be able to adapt them appropriately to both the male member 22 and the female member 10. For brevity, FIG. 1 and FIG. 2 show an example of each.

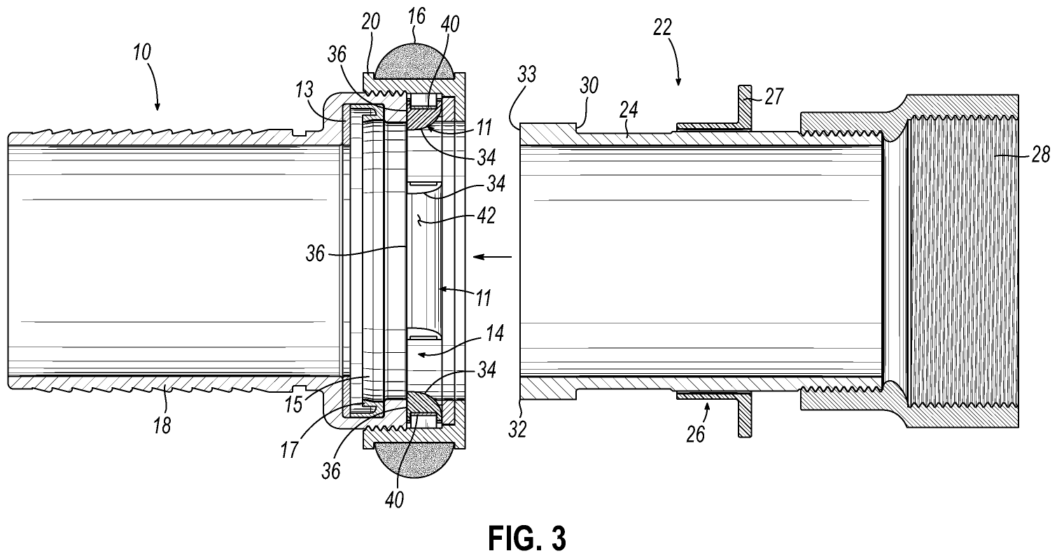

Referring next to FIG. 3, therein is shown a cross-sectional view of the female member 10 unconnected to the male member 22. The male member snout 24 should be of similar circumference to the female receptacle area 14 so as to allow the male member snout 24 to axially enter the female receptacle area 14, but not so large as to prevent the male member snout 24 from entering the female receptacle area 14. The depth of the female receptacle area 14 should be similar to the distance between the annular locking lip 30 and the leading snout end 32, so that the leading snout end 32 can axially displace the locking pawls 11 by compressing the springs 40 related to the locking pawls 11 allowing the annular locking lip 30 to lock behind the locking pawls 11.

The locking pawls 11 may have an angled or curved edge 34 and should have a straight edge 36. The angled or curved edge 34 provides a camming interaction as the male member 22 and female member 10 are moved together. The straight edge 36 provides a flat surface that engages in a tight connection with the annular locking lip 30 when the male member 22 and female member 10 are connected. The straight edge 36 is positioned closer to the face gasket 13, while the angled or curved edge 34 is farther from the face gasket 13 in relation to the straight edge 36.

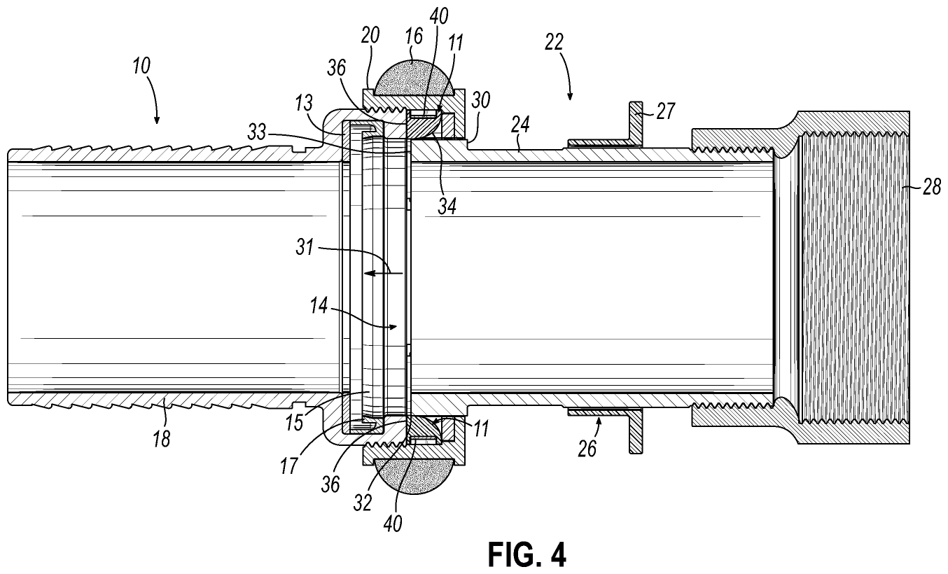

Referring next to FIG. 4, therein is shown a cross-sectional view of the female member 10 and the male member 22 with the leading snout end 32 radially displacing the locking pawls 11, after the male member snout 24 has been moved axially 31 into the female receptacle area 14. Thus, in FIG. 4, the female member 10 and the male member 22 are being moved toward each other to achieve a configuration where they are locked together. The locking pawls 11 remain axially displaced the annular locking lip 30 is in contact with the locking pawls 11.

Referring next to FIG. 5, therein is shown the fully engaged and locked cross-sectional view of the female member 10 and the male member 22. The area between the leading snout end 32 and the annular locking lip 30 has fully axially passed over the locking pawls 11 and into sealing contact with the face gasket 13. The leading snout surface 33 is in contact with the face gasket 13, which creates a fluid tight seal. The locking pawls 11 are biased back to their original positions and all of the pawl bottom straight edges 36 are in contact with the annular locking lip 30.

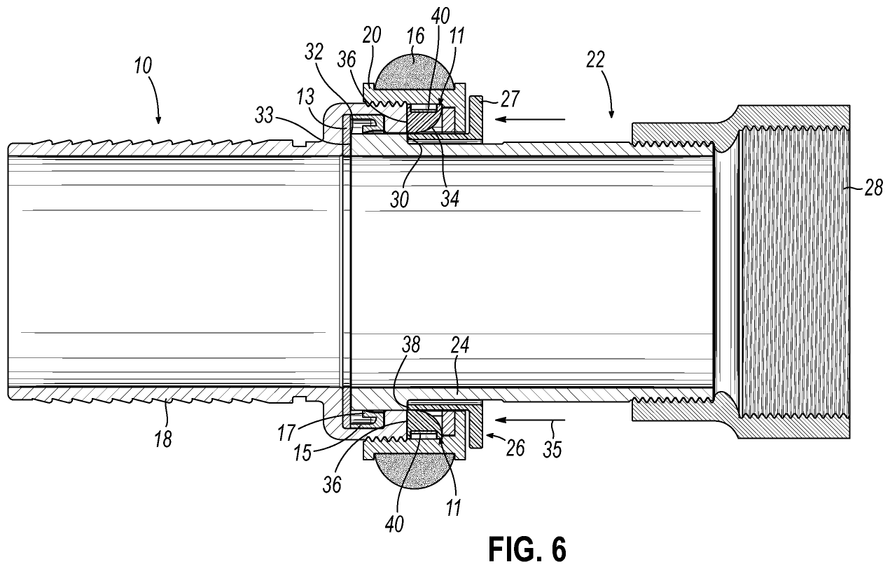

Referring next to FIG. 6, therein is shown the disengagement cross-sectional view of the female member 10 and the male member 22. The release ring 26 moved axially toward 35 the leading snout end 32 and away from the conduit connection end 28. The release ring lead edge 38 radially displaced the locking pawls 11. The release ring lead edge 38 disengaged the straight edge 36 from the annular locking lip 30 which allows the female member 10 and the male member 22 to disengage from each other. The release ring lead edge 38 may be curved or chamfered, providing a camming surface and assist the radial displacement of the locking pawls 11.

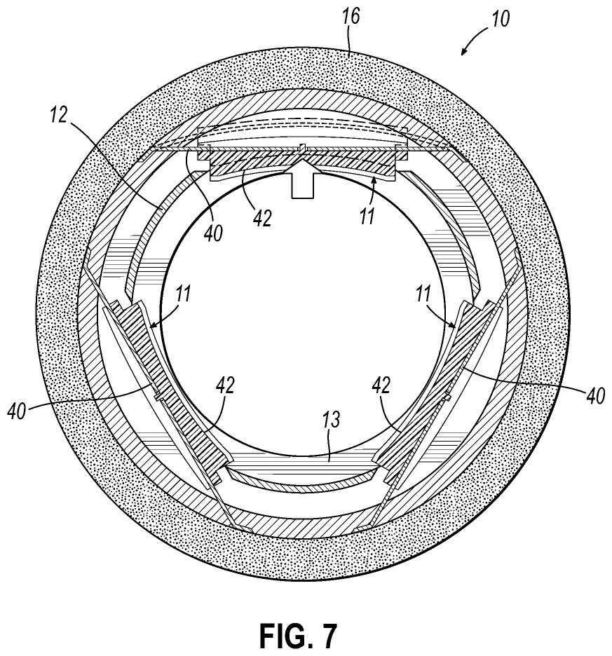

Referring next to FIG. 7, therein is shown is the cross-sectional view of the female lock housing 12.

In the illustrated embodiment, the female lock housing 12 has a plurality of locking pawls 11 with three being a workable number. The number of locking pawls 11 can be greater or less than three, but the number of locking pawls 11 should not be so great as to incur unnecessary additional manufacturing costs.

In the illustrated embodiment, the springs 40 are leaf springs, yet other types of springs such as torsion springs, compression springs, and the like could be used. The springs 40 nest behind and are flush with the locking pawls 11. The springs 40 may be attached to the locking pawls 11 by a singular connection point in the center of the springs 40 and locking pawls 11. The curved surface of the locking pawls 42 allows for the springs 40 to flex so that the male member 22 (FIG. 5) may connect with the female member 10 (FIG. 5) as the male member 22 (FIG. 5) enters the female receptacle area 14. The springs 40 should be of a resistance where the leading snout end 32 may radially displace the locking pawls 11 without excessive force. Also, the curved surface of the locking pawls 42 allows the disconnection of the male member 22 (FIG. 6) and female member 10 (FIG. 6) upon the engagement of the release ring 26 (FIG. 6). The springs 40 should be of a resistance where the release ring 26 (FIG. 6) may radially displace the locking pawls 11 without excessive force.

While one or more embodiments of the present invention have been described in detail, it should be apparent that modifications and variations thereto are possible, all of which fall within the true spirit and scope of the invention. Therefore, the foregoing is intended only to be illustrative of the principles of the invention. Further, since numerous modifications and changes will readily occur to those skilled in the art, it is not intended to limit the invention to the exact construction and operation shown and described. Accordingly, all suitable modifications and equivalents may be included and considered to fall within the scope of the invention, defined by the following claim or claims.

What is claimed is:

1. A quick-connect fitting assembly for quick connect and disconnect of a pair of fluid conduits comprising:
a male member having an elongated cylindrical snout portion, an outwardly extending annular locking lip portion, a flat leading snout surface reasonably insertable within a female member, said male member having a circumference similar to said female member so as to allow said male member to insert into the female member;
a female member having a lock housing of similar circumference to said male member so as to receive said male member upon the insertion of the male member into said lock housing, said lock housing having a plurality of locking pawls that can be radially displaced upon insertion of said male member and are spring biased, said locking pawls having a first surface edge and a second surface edge, said first surface edge may be curved to ease the insertion of said male member into said female member, said second surface edge should be a straight so that said outwardly extending annular locking lip portion may be locked inside a female receptacle area, said female member should have a gasket inside said female receptacle so that said flat leading snout surface may be flush with said gasket so as to create a fluid tight seal when said male member is inserted into said female receptacle area and locked into place;
a release ring captive on said male member snout, said release ring having a circumference similar to said male member snout but not so similar to disallow movement of said release ring on said male member snout, and said release ring having a leading edge that can disconnect said male member from said female member when said release ring engages said locking pawls in said female receptacle area.

2. A quick-connect fitting assembly for quick connect and disconnect of a pair of fluid conduits according to claim 1, wherein said release ring has a release ring flange in order to allow the easy movement of said release ring.

3. A quick-connect fitting assembly for quick connect and disconnect of a pair of fluid conduits according to claim 1, wherein said female member has an additional V-gasket.

4. A quick-connect fitting assembly for quick connect and disconnect of a pair of fluid conduits according to claim 1, wherein said locking pawls are spring biased with using leaf springs.

5. A quick-connect fitting assembly for quick connect and disconnect of a pair of fluid conduits according to claim 1, wherein said male member has a hose connection end.

6. A quick-connect fitting assembly for quick connect and disconnect of a pair of fluid conduits according to claim 1, wherein said male member has a threaded connection end.

7. A quick-connect fitting assembly for quick connect and disconnect of a pair of fluid conduits according to claim 1, wherein said female member has a hose connection end.

8. A quick-connect fitting assembly for quick connect and disconnect of a pair of fluid conduits according to claim 1, wherein said female member has a threaded connection end.

9. A quick-connect fitting assembly for quick connect and disconnect of a pair of fluid conduits according to claim 1, wherein said female member contains an elastomeric bumper.
